(19) United States
(12) Patent Application Publication
(10) Pub. No.: US 2005/0255203 A1
(43) Pub. Date: Nov. 17, 2005

(54) Method of making a fresh fruit confection with improved shelf-life

(76) Inventor: E. Donald Morando, East Greenwich, RI (US)

Correspondence Address: BARLOW, JOSEPHS & HOLMES, LTD., 101 DYER STREET, 5TH FLOOR, PROVIDENCE, RI, 02903, US

(21) Appl. No.: 11/084,902

(22) Filed: Mar. 21, 2005

Related U.S. Application Data
(60) Provisional application No. 60/571,700, filed on May 17, 2004.

(51) Int. Cl. A23B 4/00

(52) U.S. Cl. 426/302

(57) ABSTRACT

A method of making a confection using fresh fruit as a main ingredient includes the steps of freezing the fresh fruit, coating the frozen fruit with sugar solids sufficient to reach a critical mass, keeping the fruit frozen during the coating process, and sealing the coated fruit in a confection layer such as chocolate. Optimally, the critical mass if the coated frozen fruit is at least 67 Brix with water activity of at least 0.60.

### CROSS-REFERENCE TO RELATED APPLICATION

This application claims priority to earlier filed U.S. Provisional Application Ser. No. 60/571,700, filed May 17, 2004, the contents of which are incorporated herein by reference.

### BACKGROUND OF THE INVENTION

1. Field of the Invention

The present invention relates to methods of making confections that use fresh fruit as an ingredient and more particularly to a method of improving the shelf life of confections that use fresh fruit as an ingredient.

2. Background of the Related Art

Confectioners have always desired to use fresh fruit in the confections that they create. Fresh fruit, however, has a short shelf life making it generally unsuitable for mass production. Typically, fruit will only last a couple of days before becoming inedible due to decay, fermentation and mold. Therefore, there is a need for a method to improve the shelf life of confections using fresh fruit as an ingredient.

Use of artificial preservatives has been one solution that confectioners have used in the past to overcome the problem of the short shelf life of the fruit. However, the process of preparing fruit for preservation involves destroying the natural flavoring of the fruit; the most desirable characteristic of the fruit. This problem has been overcome by using artificial flavoring to reconstitute the flavor lost in the preservation process. Additionally, in our health and environmentally conscious society, it has become unacceptable to some people to ingest foods containing artificial preservatives and artificial flavorings as ingredients. Therefore, there is a need for a method to preserve the fruit for use in a confection without artificial preservatives and artificial flavorings and a method to preserve a fruit in a confection without harming the naturally flavoring of the fruit.

### SUMMARY OF THE INVENTION

The present invention solves the problems of the prior art by providing a unique process for making a confection with fresh fruit with an improved shelf life without the use of artificial preservatives and flavorings, and that retains the natural flavoring of the fruit.

An object of the present invention is the provision for a method of making a fresh fruit confection that has an improved shelf life.

Another object of the present invention is the provision for a method of making a fresh fruit confection that has a shelf life of at least six months.

Yet, another object of the present invention is the provision for a method of making a fresh fruit confection that does not require artificial preservatives to maintain its freshness.

Yet, another object of the present invention is the provision for a method of making a fresh fruit confection with an improved shelf life without damaging the natural flavor of the fresh fruit ingredients.

Yet, another object of the present invention is the provision for a method of making a fresh fruit confection that does not require artificial flavorings.

### BRIEF DESCRIPTION OF THE DRAWINGS

These and other features, aspects, and advantages of the present invention will become better understood with reference to the following description, appended claims, and accompanying drawings where:

FIG. 1 is a flow chart of the preferred embodiment of the method of the present invention; and

FIG. 2 is a cross-section of a confection made according to the preferred embodiment of the method of the present invention.

### DESCRIPTION OF THE PREFERRED EMBODIMENT

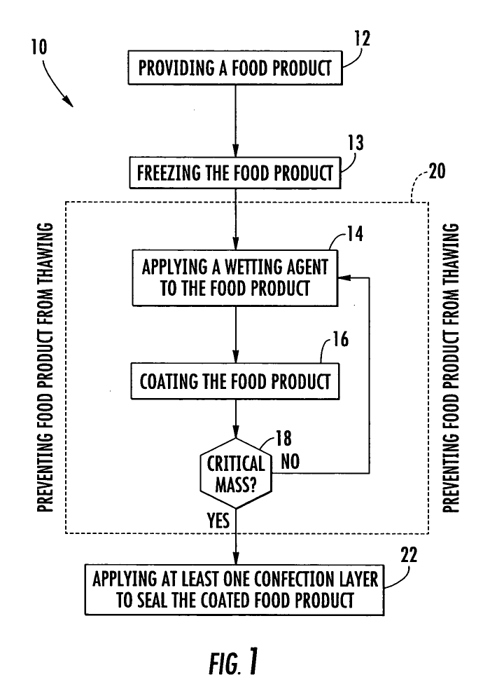

Referring now to FIG. 1, a flow chart of the preferred steps of the present invention is shown generally at 10.

In the first step, fresh food product is obtained 12. The food product can be any whole or diced fruit such as pineapples, strawberries, peaches, blueberries, blackberries, raspberries, and cherries. The food product is then frozen 13. The method of freezing the fresh fruit is preferably by well known industry methods of freezing fresh fruit such as the individually quick frozen (IQF) method, but may be by any other freezing method well known in the art. The critical aspect to the present invention is that the fresh fruit must be frozen. Selection of the best method of freezing particular varieties of fresh fruit to preserve optimal freshness, taste, and other desirable characteristics of the fruit are well known in the art.

A wetting agent is then applied 14 to the food product. Preferably, the wetting agent is a simple solution of sugar and water in a 50/50 ratio, but ratio of sugar to water is not critical and the solution may include other ingredients such as flavor enhancers or other natural flavorings. The type of sugar selected is preferably a fondant sugar such as Amerfond®, but other sugars of different coarseness or crystal size may be used. Moreover, if desired the sugar may be omitted completely and substituted with a sugar substitute or sugar free ingredient having high solubility. The wetting agent is applied to cover the individual frozen food product pieces evenly to ensure that the coating, described below, adheres to the frozen food product. Many methods are extremely well known in the art to apply a liquid to a solid, both manually and automatically, and any particular manner in applying the wetting agent to the food product is not critical to the present invention.

The food product is then coated 16 with sugar solids or if desirable, a sugar substitute having high solubility. The sugar solids are preferably a fondant sugar such as Amerfond®. For ease of description, sugar solids will be referred to throughout, but the scope of the subject matter is intended to include sugar substitutes and other sugar free ingredients as interchangeable substitutes for the sugar solids. The food product is coated with a sufficient amount of sugar solids until it reaches a critical mass. The critical mass of the food product is targeted for a sufficient weight wherein the concentration of sugar is at least 67 Brix (or an equivalent concentration of sugar substitute) and a water activity of at least 0.60. For instance, if blueberries are used according to the present invention 1 part blueberries would require approximately 1.5 parts sugar solids to reach the desired critical mass. If necessary, the wetting and coating steps are repeated 18 until the desired critical mass is achieved. The critical mass of the food product is a sufficient build up of sugar solids on the food product that will retard microbial and/or chemical deterioration of the food product. The sugar solids dissolve in the water naturally occurring in the food product as it thaws, thereby locking the water up and behaving as a natural preservative to the now thawed product.

Many methods are extremely well known in applying a granular or powdered substance to a solid, no particular method being critical to the present invention herein. By way of example and not of limitation, one such method would be using a revolving container. The food product is loaded into the container or pan and the sugar solids are added into the pan. The container generally revolves at a rate of 20 RPM, thereby gently agitating and mixing the contents together. Within the industry this process is commonly referred to as “panning.”

During the wetting and coating of the food product, it is critical that the food product remain 20 frozen. If the food product thaws during the application or the coating steps, it will become an unusable mass. One method to keep the food product frozen is to add pellets of dry ice to the food product during the wetting and coating processes. Alternatively, spraying CO₂ or liquid N₂ onto the food product would also work equally well. Another alternative that would also work well would be to prepare the food product in a refrigerated room or a freezer environment substantially between 0 and 10 degrees Fahrenheit. Blowing super cold air roughly between 0 and 10 degrees Fahrenheit, would also work well. The method of keeping the food product frozen is not critical; the key to the process is that the food product must be kept firm or at a temperature between 0 and 20 degrees Fahrenheit is order for the food product to support itself during the process of adding the required amount of sugar solids to reach the critical mass.

Once the coated food product has reached the proper critical mass, the food product must be sealed 22 in a confection layer, such as chocolate or yogurt. Covering a confection in chocolate, or a similar out confection layer, is extremely well known in the art. The process basically consists of adding a bottom confection layer to the coated food product and then enrobing the coated food product in another confection layer. These steps are commonly referred to as “bottoming” and “enrobing” within the art. The resulting confection thus consists of the coated food product sealed within the confection layer. The bottoming and enrobing steps may be repeated as desired to decrease the likelihood of a leak in the confection layer.

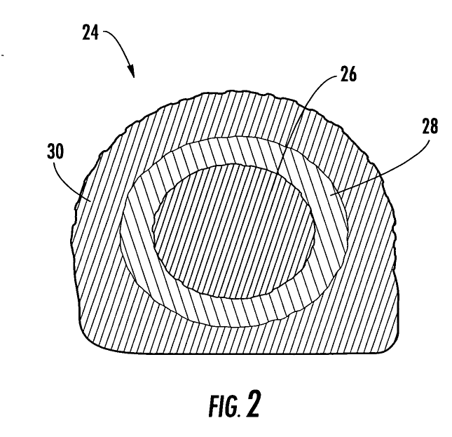

The finished confection, shown in FIG. 2 at 24, has a product center 26 covered in a sugar solid coating 28 (or sweetener coating) and bottomed and enrobed in a confection layer 30, such as chocolate. As mentioned previously, as the product thaws, the water naturally occurring in the product mixes with the sugar solid layer 28 surrounding the product center forming syrup that naturally preserves the product. Additionally, the confection layer 30 seals in the thawed product 26 and the syrup from the outside air to further prolong the shelf life of the confection.

The finished confection may then be packaged for display, storage and shipping using well known conventional methods or further processed to add adornments and other ingredients as desired.

By use of the method of the present invention, extended shelf life of at least six months and upwards of one year or more is attainable. Therefore, it can be seen that the present invention provides a new and unique method of creating a confection with fresh fruit that has an improved shelf life.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

1. A method of making a confection, comprising:
providing a food product having an outer surface;
freezing the food product;
coating the outer surface of the food product with a sweetener coating until the food product reaches a critical mass resulting in a coated food product;
preventing the food product from thawing during the coating of the food product; and
applying at least one confection layer to seal the coated food product therein.

2. The method of claim 1, further comprising applying a wetting agent to the food product prior to coating the food product.

3. The method of claim 2, wherein the wetting agent comprises a solution of water and sugar.

4. The method of claim 1, wherein the sweetener coating is sugar solids.

5. The method of claim 1, wherein the food product is fresh fruit.

6. The method of claim 1, wherein the coated food product has a concentration of sweetener of at least 67 Brix.

7. The method of claim 1, wherein the coated food product has a water activity of at least 0.60.

8. The method of claim 1, wherein the confection layer is chocolate.

9. A method of making a confection, comprising:
providing food product having an outer surface;
freezing the food product;
applying a wetting agent to the food product;
coating the outer surface of the food product with a sweetener coating;
repeating the application of the wetting agent and the coating of the food product until the food product reaches a critical mass resulting in a coated food product;
preventing the food product from thawing during the application of the wetting agent and the coating of the food product; and
applying at least one confection layer to seal the coated food product therein.

10. The method of claim 9, wherein the food product is fresh fruit.

11. The method of claim 9, wherein the wetting agent comprises a solution of water and sugar.

12. The method of claims 11, wherein the wetting agent further comprises artificial flavoring.

13. The method of claim 9, wherein the sweetener coating is sugar solids.

14. The method of claim 9, wherein the coated food product has a concentration of sugar of at least 67 Brix.

15. The method of claim 9, wherein the coated food product has a water activity of at least 0.60.

16. The method of claim 9, wherein the confection layer is chocolate.

17. A method of making a confection, comprising:
providing frozen fruit;
applying a wetting agent to the frozen fruit;
coating the frozen fruit with sugar solids;
repeating the application of the wetting agent and the coating of the frozen fruit until the frozen fruit reaches a critical mass resulting in coated frozen fruit whereby the coated frozen fruit has a concentration of sugar of at least 67 Brix and water activity of at least 0.60;
preventing the frozen fruit from thawing during the application of the wetting agent and the coating of the frozen fruit; and
applying at least one confection layer to seal the coated frozen fruit therein.

18. The method of claim 1, wherein the wetting agent comprises a solution of water and sugar.

19. The method of claim 1, wherein the confection layer is chocolate.
